(19) United States
(12) Patent Application Publication
(10) Pub. No.: US 2024/0253133 A1
(43) Pub. Date: Aug. 1, 2024

(54) Drill Bit and Associated Method of Making a Drill Bit

(71) Applicant: C4 Carbides Limited, Newmarket (GB)

(72) Inventor: Paul Duggan, Newmarket (GB)

(21) Appl. No.: 18/633,208

(22) Filed: Apr. 11, 2024

Related U.S. Application Data
(63) Continuation of application No. PCT/GB22/52416, filed on Sep. 23, 2022.

(30) Foreign Application Priority Data
Oct. 14, 2021 (GB) 2114668.3

(51) Int. Cl. B23B 51/04; B23P 15/28

(52) U.S. Cl. CPC B23B 51/04; B23P 15/28

(57) ABSTRACT

There is provided a method of making a drill bit including a base portion and a cutting portion. In the method, the base portion and the cutting portion are provided as separate pieces. The cutting portion is heat treated to form a cutting surface having braze material and abrasive particles. After heat treatment, the base portion is attached to the cutting portion. The abrasive particles may be substantially spherical diamond particles and have a diameter in the range 300-700 microns. A drill bit being a grinding pin or hole saw is also provided.

### CROSS-REFERENCE TO RELATED PATENT APPLICATIONS

This application is a continuation of International Application No. PCT/GB2022/052416, filed Sep. 23, 2022, which claims the benefit of and priority to GB Application No. 2114668.3, filed Oct. 14, 2021, each of which is incorporated herein by reference in its entirety.

### FIELD

This invention relates to drill bit such as a grinding pin or hole saw and an associated method of making such a drill bit.

### BACKGROUND

When manufacturing drill bits and the like a ductile braze material is used to bind abrasive particles such as diamond particles to a drill bit surface. This is generally done by placing the braze material and abrasive particles onto part of the drill bit, then heating the drill bit within a furnace with the braze melting, and then cooling the drill bit to ensure the braze solidifies and binds the abrasive particles to the drill bit. To ensure an even distribution of the abrasive particles on the drill bit, the absolute temperature, the uniformity of temperature and the time at temperature within the furnace must be accurately controlled. If these aspects are not controlled, problems can occur with uneven distribution and protrusion of the abrasive particles which impacts on drilling performance of the completed drill bit.

If excessive temperature is experienced within the furnace, the abrasive particles can float on the liquid braze and agglomerate, preventing a uniform distribution of particles which is critical to consistent performance of the drill bit during drilling.

If the drill bit spends an excess of time at temperature within the furnace, there can be excessive braze flow covering the abrasive particles and reducing the amount the particles protrude from the braze in the finished drill bit, again impacting performance.

If the heating and cooling within the furnace is not consistent then production batches of drill bits will be inconsistent in performance.

### BRIEF SUMMARY

In accordance with a first aspect of the invention, there is provided a method of making a drill bit comprising a base portion and a cutting portion, the method comprising providing the base portion and the cutting portion as separate pieces, heat treating the cutting portion to form a cutting surface comprising braze material and abrasive particles, and after heat treatment attaching the base portion to the cutting portion. By treating the cutting portion independently of the base portion, the heat treatment provides an improved cutting surface.

The base portion may be attached to the cutting portion by welding, such as one or more spot welds, typically by laser welding. Another option for attachment is providing the base portion and cutting portion with complementary screw threads and using a thread lock adhesive to secure the portions together.

The heat treatment preferably comprises heating the cutting portion in a furnace, holding the furnace at a set temperature and then cooling to achieve a cutting surface comprising braze material and abrasive particles. Typically the cooling is quench cooling so as to achieve rapid cooling.

Preferably the abrasive particles are diamond particles, preferably substantially spherical with a diameter in the range 300-700 microns.

The base portion is preferably configured to be retainable within a chuck on a rotary tool, such as an angle grinder or rotary drill, so as to achieve rotation of the drill bit.

In accordance with a second aspect of the invention, there is provided a drill bit comprising a base portion and a cutting portion, wherein the cutting portion comprises a cutting surface comprising braze material and abrasive particles and the cutting portion is formed separately to the base portion, and fixing means attaches the base portion to the drilling portion.

Preferably the abrasive particles are diamond particles, preferably substantially spherical with a diameter in the range 300-700 microns.

The drill bit may be a grinding pin or a hole saw.

The drill bit as aforesaid is particularly advantageous when used with a drilling tool operating between 500 to 30,000 rpm such as angle grinders, rotary drills and high speed rotary tools and is of particular advantage for angle grinders operating between 8000 to 14,000 rpm.

### BRIEF DESCRIPTION OF THE DRAWINGS

The invention will now be described by way of example with reference to the accompanying drawings in which:

FIG. 1 is a perspective view of a first embodiment of a drill bit;

FIG. 2 is a perspective view of the first embodiment showing the two-part structure;

FIG. 3 is a perspective view of a second embodiment of a drill bit;

FIG. 4 is a cross-section through one version of the second embodiment; and

FIG. 5 is a cross-section through an alternative version of the second embodiment.

### DETAILED DESCRIPTION

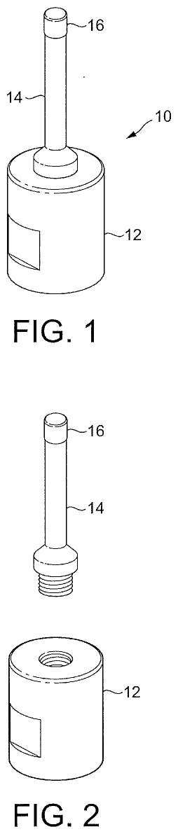

FIG. 1 shows a drill bit 10, also known as a hole saw, comprising a base portion 12 and a cutting portion 14 on which is deposited a cutting surface 16 comprising abrasive particles secured in place using a braze material. Such a drill bit is suitable for cutting apertures in hard tiles and stone and is typically attached by base portion 12 to an angle grinder so that cutting portion 14 is rotatable at high speed to engage a workpiece and remove workpiece material.

As shown in FIG. 2, drill bit 10 is formed as two separate parts. Forming drill bit 10 as two separate parts allows smaller cutting portion 14 to be heat treated independently of base portion 12. Thus cutting portion 14 is treated with braze and abrasive particles and heated in a furnace to bind the abrasive particles in place, with larger heavier base portion 12 secured to the coated second part 14 later, base portion 12 thus not entering the furnace at any stage.

The more uniform cross-section portion 14 placed in the furnace will respond to furnace conditions more consistently over its surface. If, for example, a drill bit formed as one piece, as in the prior art with base and cutting portion conjoined, is introduced into a furnace then the irregular shape of such a drill bit means that furnace heating of the drill bit at an end distal base portion 12 will be different to furnace heating close to the heavy base 12. This makes it hard to control the binding process and ensure braze melting is consistent along the region of the cutting portion to which the abrasive material is to be secured to create cutting surface 16. By instead forming drill bit 10 as two separate portions with only cutting portion 14 that requires coating with abrasive particles being placed in the furnace, a more uniform distribution of abrasive particles and a more consistent protrusion of abrasive particles as secured by the braze material is achievable, enabling high-volume production of batches of drill bits with consistent performance.

Prior to placing cutting portion 14 in a furnace, braze powder and abrasive particles are applied onto cutting portion 14 in the region where cutting surface 16 is to be located. The abrasive particles are typically diamond although can be other materials such as tungsten carbide or cubic boron nitride. A mixture of abrasive particles of different materials can be used. The diamond particles are selected to be generally spherical with an average grain size of 300-700 microns as to create a cutting surface which combines good cutting speed with durability.

After initial coating with the braze powder and abrasive particles, cutting portion 14 is placed in a furnace and heated under controllable conditions to ensure the braze material melts and is then re-solidified to bind the abrasive material to cutting portion 14. Typically the heating process involves heating to around 1000 to 1200° C., holding this set temperature for a short time, typically around 30 seconds, and then rapidly cooling by quenching to around 400° C. in 150 to 200 seconds to solidify the molten braze material and so bind and secure the abrasive particles.

After cutting surface 16 has been formed on cutting portion 14, the large heavier base 12 is secured to cutting portion 14, either using a screw thread with a thread lock adhesive or using spot welding, typically by laser welding.

By heat treating cutting portion 14 independent of base 12, the abrasive particles are more evenly distributed throughout cutting surface 16 and have a more consistent protrusion above the braze material due to the heat distribution within the furnace being better controlled in relation to the more uniformly shaped cutting portion 14.

The improved control of heat during the binding process ensures that cutting surface 16 is less likely to suffer from diamonds being pulled out of the solidified braze material as the depth of braze bond in relation to diamond protrusion is more consistent and the diamond particles are more evenly distributed due to improved control of the braze melting. This ensures such a drill bit has improved cutting speed and tool durability when cutting materials such as porcelain and granite.

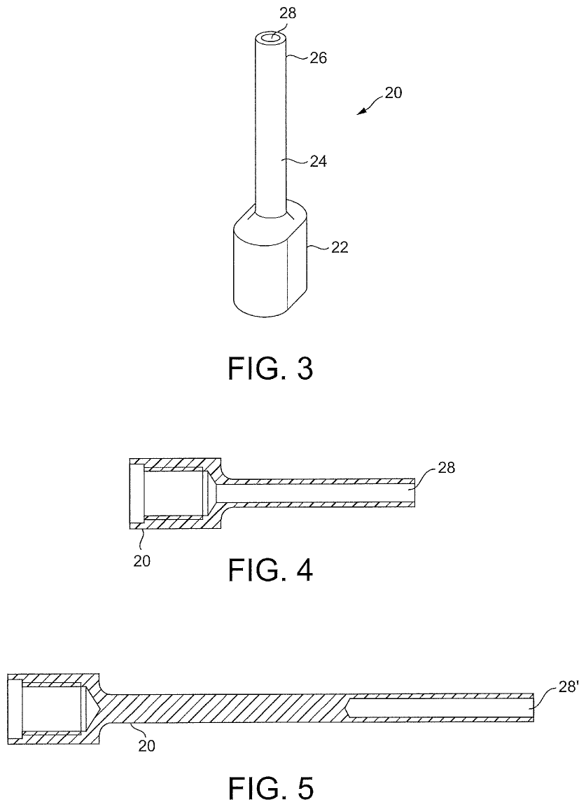

An alternative type of drill bit 20, being a grinding pin, is shown in FIG. 3, this being for attachment to an angle grinder or other type of drilling tool. Drill bit 20 is similarly formed as two separate pieces, base piece 22 and cutting portion 24 having a cutting surface 26 comprising abrasive particles bound in position by braze material. Drill bit 20 is formed with a central channel which either extends along the length of cutting portion 24 to reach base 22, see channel 28 in FIG. 4, or extends partially along the length of cutting portion 24, see channel 28′ in FIG. 5. As with the embodiment shown in FIGS. I and 2, cutting portion 24 is separated from base 22 before heat treatment to bind braze material and abrasive particles to cutting portion 24. After the binding process has been completed, then cutting portion 24 is attached to base 22, typically by thread lock adhesive or by welding. FIGS. 4 and 5 show drill bit 20 after heat treatment of cutting portion 24, with base 22 and cutting portion secured to each other by welding.

What is claimed is:

1. A method of making a drill bit comprising a base portion and a cutting portion, the method comprising:
providing the base portion and the cutting portion as separate pieces;
heat treating the cutting portion to form a cutting surface comprising braze material and abrasive particles; and
attaching, after heat treatment, the base portion to the cutting portion.

2. The method according to claim 1, wherein the base portion is attached to the cutting portion by welding.

3. The method according to claim 1, wherein the base portion is attached to the cutting portion by adhesive.

4. The method according to claim 1, wherein the heat treating comprises:
heating the cutting portion in a furnace;
holding the furnace at a set temperature; and
cooling to achieve a cutting surface comprising braze material and abrasive particles.

5. The method according to claim 4, wherein the heating comprises heating to a first temperature in a range of 1000° C. to 1200° C., wherein the holding is performed for about 30 seconds, and where the cooling comprises quenching to a second temperature of about 400° C. in 150 to 200 seconds.

6. The method according to claim 1, wherein the abrasive particles are diamond particles.

7. The method according to claim 6, wherein the diamond particles are substantially spherical and have a diameter in the range 300-700 microns.

8. The method according to claim 1, wherein the abrasive particles comprise tungsten carbide or cubic boron nitride.

9. The method according to claim 1, wherein the cutting surface extends only over a tip section of a length of the cutting portion.

10. The method according to claim 1, wherein the base portion is configured to be retainable within a chuck on a rotary tool.

11. A drill bit, comprising:
a base portion; and
a cutting portion;
wherein the cutting portion comprises a cutting surface comprising braze material and abrasive particles; and
wherein the cutting portion is formed separately to the base portion and fixing means attach the base portion to the cutting portion.

12. The drill bit according to claim 11, wherein the abrasive particles are diamond particles.

13. The drill bit according to claim 12, wherein the diamond particles are substantially spherical and are 300-700 micron in diameter.

14. The drill bit according to claim 11, wherein the abrasive particles comprise tungsten carbide or cubic boron nitride.

15. The drill bit according to claim 11 being a grinding pin.

16. The drill bit according to claim 11 being a hole saw.

17. The drill bit according to claim 11, configured to be used with a drilling tool operating between 500 to 30,000 rpm.

18. The drill bit according to claim 11, wherein the cutting surface extends only over a tip section of a length of the cutting portion.

19. The drill bit according to claim 11, wherein the cutting portion comprises a central channel.

20. The drill bit according to claim 19, wherein the central channel only extends partially along the length of cutting portion.
